(19) United States
(12) Patent Application Publication
(10) Pub. No.: US 2003/0155026 A1
(43) Pub. Date: Aug. 21, 2003

(54) Asymmetrical interference pulsation dampener

(76) Inventors: Vladimir Abramovich Michlin, Yogneam Illit (IL); Igor Igorevich Stukanov, Yogneam Illit (IL)

Correspondence Address: Vladimir Michlin, Apt. 6, 27 Zeelim Str., Yogneam Illit, 20692, IL

(21) Appl. No.: 10/278,090

(22) Filed: Oct. 23, 2002

Related U.S. Application Data
(63) Continuation-in-part of application No. 10/079,686, filed on Feb. 21, 2002.

(51) Int. Cl. F16L 55/04

(52) U.S. Cl. 138/26; 138/42

(57) ABSTRACT

A reliable, compact, and efficient asymmetrical interference pulsation dampener is intended for the reduction of pulsation in hydraulic or pneumatic systems and their pressure head pipelines. Basic elements of the dampener are interference disks or combinations of rigid concentric cylinders, which divide the stream of a fluid or gas for the purpose of reducing the pulsation through negative interference. In relation to the central channel, the secondary channel of the dampener is made with a reduced section. The power wave balance at the merging point of the channels is established through the acoustic resonators built into the dampener.

### CROSS-REFERENCE TO RELATED APPLICATIONS

This application is a continuation-in-part application of application Ser. No. 10/079,686 filed Feb. 21, 2002.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to a pulsation dampener and particularly to an apparatus that reduces the effect of pulsations of liquid or gas flows in a hydraulic or pneumatic system that includes a pumping device.

2. Background Information

Pulsations and accompanying vibrations and noise arising as the result of a pump's work causes additional loads that exceed the average pressure in a system. In addition, the noise has a negative impact on human health. Due to pulsations and vibrations, a hydraulic or pneumatic system is exposed to negative influences that reduce the exploitation terms and increase the risk of a breakdown. Depending on the system (airplane, oil pipeline, etc.), the results of a breakdown may have catastrophic consequences.

The simplest constructive way to reduce the risk of a breakdown due to pulsations in the system is to increase the thickness of the walls in the pipelines of hydraulic or pneumatic systems. As a result, the price and the weight of the systems would increase.

To reduce the costs and weight of hydraulic or pneumatic systems, pulsation dampeners are used. Some of the latest patents in the pulsation-reduction field deal with changes in pump design, and therefore they are not applicable to the pump systems that currently exist or to future systems that will rely on traditional pumps. Systems in which such pulsation-modified pumps are used will be expensive compared to systems in which traditional pumps are used.

Today the majority of companies use separate devices-pulsation dampeners to reduce pulsations in hydraulic/pneumatic systems. There are two approaches to solving this problem by using these devices. The first approach consists of using a dampening element (for example, volume of gas or fluid separated by membranes or forcers from the main flow) to absorb or damper pulsations in the flow.

More than 100 inventions based on this method have been proposed. The most advanced dampeners of this type are described in U.S. Pat. No. 4,273,158 Chun, No. 5,505,228 Summerfield, No. 5,797,430 Becke, No. 5,860,452 Ellis, No. 6,086,336 Welschof and Russian Patents No. 2,029,906 Prokhorov, and No. 2,156,912 Nizamov. All devices of this type demonstrate low reliability due to the existence of moving parts such as membranes and forcers. In addition, they require frequent monitoring and adjustment of working parameters such as the pressures of absorbing or dampening volumes.

The second approach consists of using the interference of 180-degree phase-shifted waves to reduce pulsation in a system. U.S. Pat. No. 5,145,339 Lehrke and No. 5,993,174 Konishi disclose pulseless pumps in which the phase-shifted waves were created in separate cylinders of the pump. These constructions are very efficient but still not reliable. They are also complex and have a narrow sphere of application.

U.S. Pat. No. 5,957,664 Stolz; No. 6,155,378 Qatu; and a series of patents U.S. Pat. No. 6,125,890; No. 6,240,964; No. 6,269,841; No. 6,279,613; No. 6,338,363 Chen disclose dampeners in which phase-shifted waves are formed by reflections from parts of the devices. These constructions are more reliable than previous inventions but are less efficient due to energy loss during reflections. In addition, in systems with low-frequency pulsations, the dampeners tend to be large in size.

Russian Patent No. 626,304 Michlin discloses a dampener in which a phase-shifted wave is formed in a secondary channel of an interference disk. This dampener has none of the drawbacks of the previous inventions, but it is only applicable to a narrow interval of frequencies and is not compact enough in the case of low-frequency pulsations.

In the application Ser. No. 10/079,686 filed Feb. 21, 2002, an advanced modification of the previous dampener, which is cheap to produce, highly reliable, and highly efficient for a wide range of temperatures, frequencies, pressures, and flow velocities was described. But due to the dependency of the dampener's sizes on the diameter of a pipeline, this dampener is not convenient for pipelines with large diameters.

The objective of the present invention is to eliminate this dependency to a great extent and at the same time preserve all the advantages of the previous invention. This allows significant expansion of a scope of applications for the given invention so that it can also be used on the main pipelines of petroleum, fuel, and gas, which have large diameter pipes.

### BRIEF SUMMARY OF THE INVENTION

The present invention is a compact, efficient, and reliable interference pulsation dampener for hydraulic or pneumatic systems that consists of a direct central channel with a diameter equal to the diameter of the head pipeline and secondary channels with reduced sections formed by notches on the interference disk or by walls of concentric cylinders.

The disks or cylinders are designed and placed in a way that maximizes the efficiency of the dampener on the required spectrums of the frequencies (of pulsations), temperatures, pressures, and velocities of flow in the system.

The central and secondary channels separate the initial pulsated flow into several flows in which 180-degree phase-shifted pulsation waves are formed. These waves interfere where the channels are connected, resulting in the reduction of pulsations in the output flow.

In relation to the central channel, the secondary channel of the dampener is made with a reduced section. The power-wave balance at the merging of streams is established through the acoustic resonators built into the dampener.

### BRIEF DESCRIPTION OF SEVERAL VIEWS OF THE DRAWINGS

FIG. 1—Asymmetrical pulsation dampener with interference disk, in which the method of direct interference is used.

FIG. 2A—Modified interference disk of the dampener on FIG. 2.

FIG. 2B—Section A-A in interference disk on FIG. 2A

FIG. 2C—View E on interference disk of FIG. 2A.

FIG. 3—Bushing with holes of the dampener on FIG. 1.

FIG. 4—Flat circular spring of the dampener on FIG. 1.

FIG. 5—Asymmetrical pulsation dampener with an interference disk, in which the method of reflected wave interference is used.

FIG. 6—Asymmetrical pulsation dampener with a set of concentric cylinders, in which the method of reflected waves interference is used.

FIG. 6A—Section A-A in the dampener on FIG. 6

### DETAILED DESCRIPTION OF THE INVENTION

The present invention is directed to a pulsation dampener for hydraulic or pneumatic systems and is described below in several examples.

### EXAMPLE 1

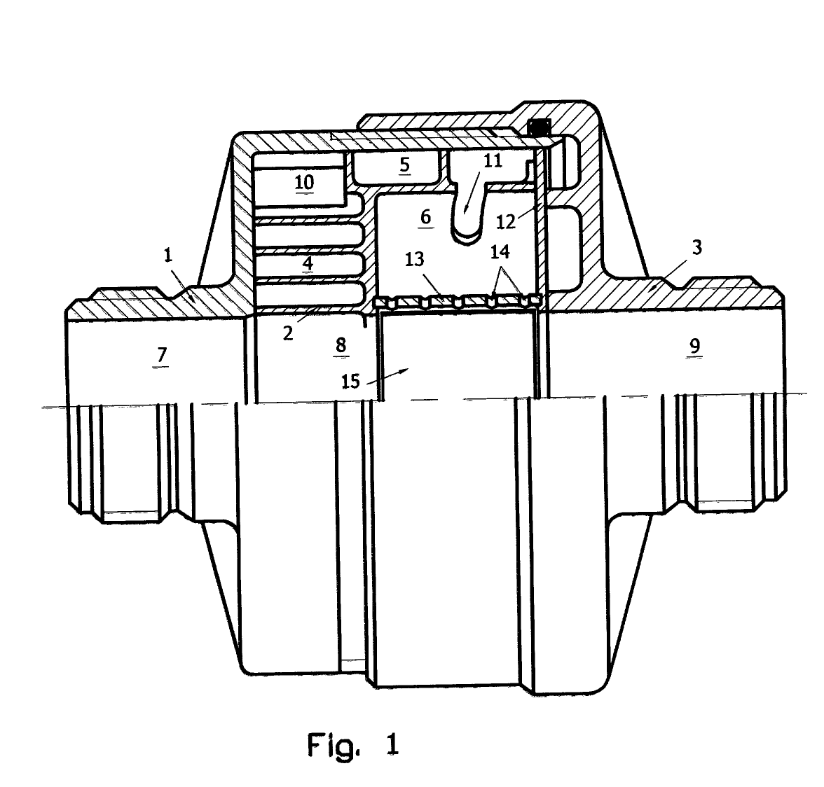

### FIGS. 1-4

FIG. 1 shows the asymmetrical interference pulsation dampener with the modified interference disk in which a method of direct interference is used.

The dampener consists of a hood 1 with an input channel 7, interference disk 2, acoustic resonator 6, and a cover 3 with an output channel 9. The acoustic resonator 6 is formed by two walls of the disk, strapping spacer 12 and bushing 13 with perforated holes 14. Inside the bushing 13 along the central channel 8 is situated flat circular spring 15.

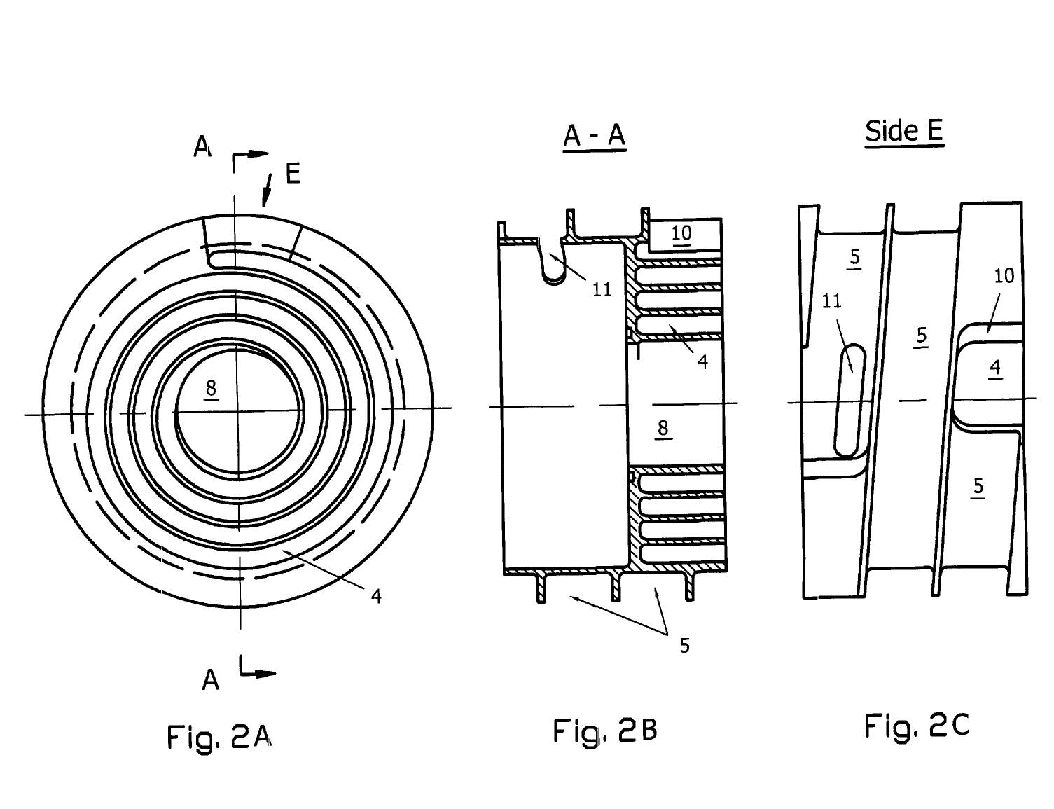

The disk 2 (FIGS. 2A-2C) has two channels: central and secondary. In the center of the disk passes the central channel 8, which has the same section and central axe as the input and output channels. This results in excluding hydraulic or pneumatic shocks and pressure swings in the fluid or gas.

The secondary channel of disk 2 consists of two parts 4, 5. Part of the secondary channel 4 in the form of an Archimedes spiral passes on the flat side of the disk and through its connecting hole 10 (FIGS. 2B, 2C) is connected with its second part 5, formed on the cylindrical side of the disk. The general length of the secondary channel (including the phase shift in the resonator 6) is half of the length of the main wave of pulsation in the central channel 8. The ratio of the lengths of parts 4, 5 is set up in such a way as to ensure the required efficiency of the dampener on given spectrums of frequencies.

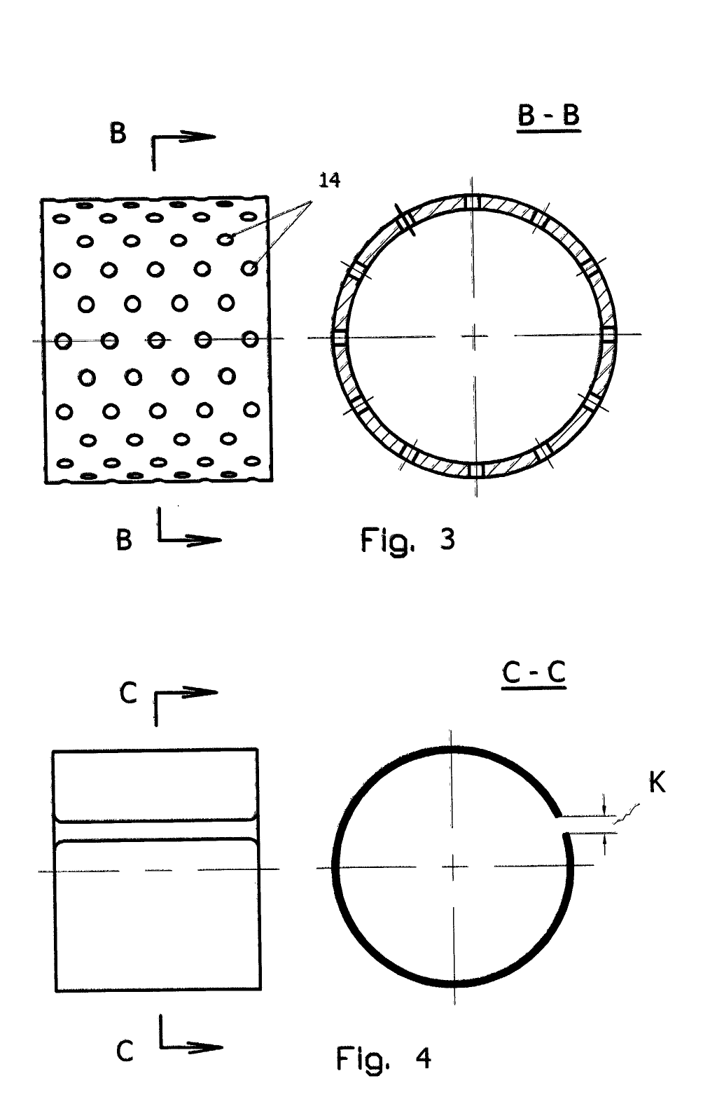

FIG. 2C shows view E on the cylindrical part of the secondary channel 5, where its desk side is examined and, through the hole 10, adjoin part of the secondary channel 4. The cavity of resonator 6 and part of the central channel 8 is formed by the cylindrical walls of the bushing 13 (FIG. 3).

The dampener functions as follows: The pulsating flow of a fluid or gas through the input channel 7 enters into the central channel 8, where a part of the flow passes into the spiral part 4 of the secondary channel. Hereafter, flow from this part of the secondary channel through the hole 10 moves to the cylindrical side of this disk in the watercourse of part 5 of the secondary channel. On its cylindrical spirals through connecting holes 11 (FIGS. 2B, 2C) the flow passes into the circular cavity of resonator 6. In the cavity of resonator 6, the pulsation of the secondary channel is intensified in amplitude to the level of pulsation in the central channel. From the resonator 6 via holes 14 pulsation, shifted in phase by 180 degrees, comes to the central channel 8, where interference comes into play. Then a general flow with reduced pulsation moves to the pipeline of the hydraulic or pneumatic system through the output channel 9.

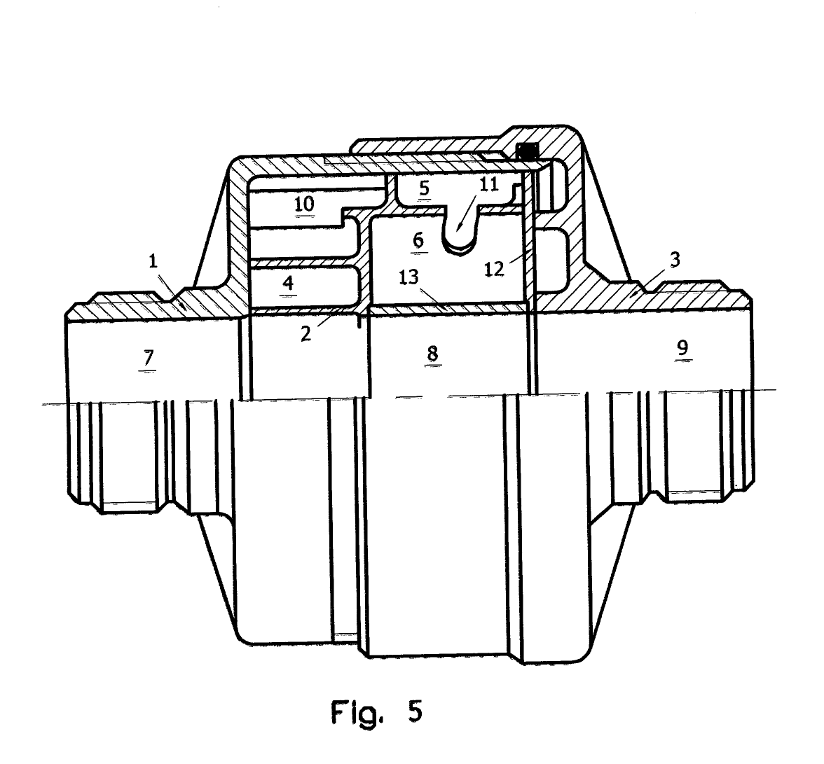

Note that bushing 13 has several functions. It functions as a reflecting surface of the resonator 6 and as a conducting surface through the holes 14 of the pulsation beside the central channel 8 (FIG. 4).

To improve the frequency selection of amplified pulsation, flatly circular springs may be used inside and outside of the resonator as shown in FIG. 1. FIG. 4 shows such a spring in example 1.

In the following designs of current invention, dampeners are described that use the method of reflected wave interference.

### EXAMPLE 2

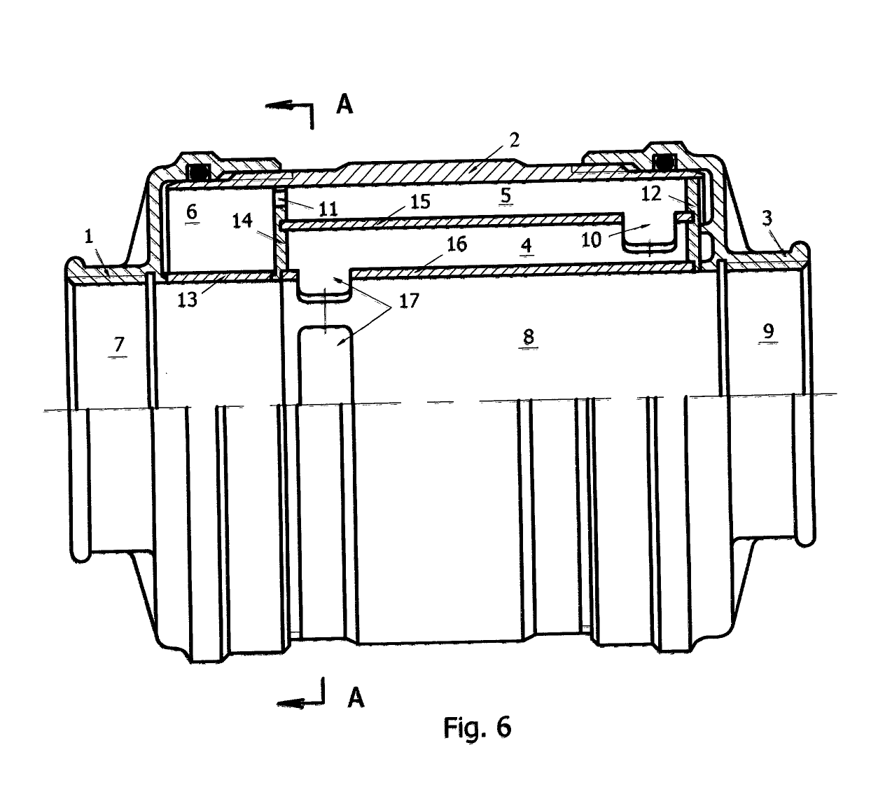

### FIG. 5

The design of this dampener coincides with the design presented in example 1 with the exception of some elements. Use in this design of the method of reflected wave interference makes it possible to decrease the length of the secondary channel.

This dampener functions as follows: Just as in the dampener in example 1, the pulsation of the flow enters the central channel 8, and it passes through parts 4, 5 of the secondary channel, and then into the acoustic resonator 6. In the resonator, the pulsation is amplified. Waves of pulsation are reflected by the wall of the bushing 13 and again return along the secondary channel of the disk 2 to the central channel 8. Here, at the location of the separation of the channels, the reflected wave of pulsation interferes with the initial wave. Hereafter, a general flow with reduced pulsation moves to the pipeline of the hydraulic or pneumatic system through the output channel 9.

### EXAMPLE 3

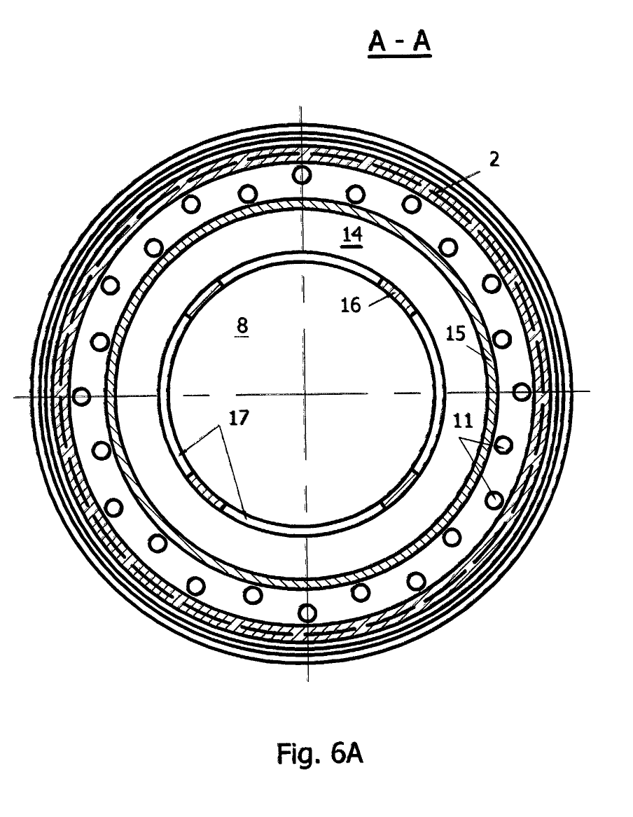

### FIGS. 6,6A

This dampener is executed in the form of the collection of the concentric cylinders, which includes the housing of the dampener 2, the bushing 13, and the separating tubes 15, 16. In this dampener, the central channel 8 is formed by placing the bushing 13 and the tube 16 consecutively. Part 4 of the secondary channel is formed by the external wall of the tube 16 and by the internal wall of another tube 15. Accordingly, part 5 of the secondary channel is formed by the walls of the tube 15 and the housing 2. From the ends, the parts of the secondary channel 4, 5 are locked by flat spacers 12, 14. The annular cavity of the acoustic resonator 6 is formed by the cylindrical walls of the housing 2, the bushing 13, the flat walls of the cover 1, and the spacer 14. This dampener also has a cover 1 with an input channel 7 and a cover 3 with an output channel 9.

FIG. 6A shows the spacer 14 with perforated apertures 11.

A dampener with such design functions as follows: The pulsation of the flow through the input channel 7 of the cover 1 enters into central channel 8 and it passes via holes 17 into part 4 of the secondary channel, then via hole 10 into part 5 of the secondary channel. From this part, the pulsation enters into acoustic resonator 6 via apertures 11 of the spacer 14. In the resonator the pulsation is amplified. Waves of pulsation are reflected by the solid wall of body 1 and pass back through the apertures 11 of the spacer 14 to the secondary channel. Along the secondary channel, via hole 17, the pulsation passes to the central channel 8. Here, at the location of the separation of the channels, the reflected wave of pulsation interferes with the initial wave. Then a general flow with reduced pulsation moves to the pipeline of the hydraulic or pneumatic system through the output channel 9.

1. An asymmetrical interference pulsation dampener for reducing the effects of pulsation in a hydraulic or pneumatic system for wide spectrums of frequencies, temperatures, pressures, and velocities of a flow in the system, which is reliable and compact, comprised of a central channel with a diameter equal to the diameter of the pressure head pipeline and the same central axe; secondary channels of the small section; and has fluid or gas pulsation amplifiers built in the dampener.

2. The pulsation dampener as in claim 1, wherein the central and secondary channels can be made into an interference disk.

3. The pulsation dampener as in claim 1, wherein the central and secondary channels can be made as a set of rigid concentric cylinders around the central channel

4. The pulsation dampener as in claim 1, wherein the amplifier of fluctuations the acoustic resonator made as ring volume, formed by rigid flat and cylindrical walls, with at least one of the walls having apertures.

5. The pulsation dampener as in claim 2, wherein inside and/or outside of the acoustic resonator, between the acoustic resonator and the central or secondary channels, flat-ring springs may be established.
